(19) United States
(12) Patent Application Publication
(10) Pub. No.: US 2004/0170267 A1
(43) Pub. Date: Sep. 2, 2004

(54) Authorization-based forwarding

(76) Inventor: Doree Duncan Seligmann, New York, NY (US)

Correspondence Address: DEMONT & BREYER, LLC, SUITE 250, 100 COMMONS WAY, HOLMDEL, NJ, 07733, US

(21) Appl. No.: 10/375,663

(22) Filed: Feb. 27, 2003

(51) Int. Cl. H04M 3/42

(52) U.S. Cl. 379/211.01

(57) ABSTRACT

A method and apparatus for forwarding signals directed to a first telecommunications terminal to a second telecommunications terminal only when such forwarding is authorized are disclosed. In particular, the illustrative embodiment employs an authorization table associated with the first telecommunications terminal and an authorization table associated with the second telecommunications terminal and forwards signals directed to the first terminal to the second terminal only when the authorization tables indicate that such forwarding is permitted.

### FIELD OF THE INVENTION

The present invention relates to telecommunications in general, and, in particular, to forwarding a call or message from one telecommunications terminal to another.

### BACKGROUND OF THE INVENTION

Telephone calls are sometimes forwarded from one telephone to another. For example, a user leaving for work in the morning might forward his or her home telephone to his or her work telephone so that calls made to his or her home telephone number will ring at his or her work telephone instead of his or her home telephone. As another example, a user might receive a call at his or her work telephone and decide to transfer the call to another telephone (e.g., a secretary's telephone, etc.) while the call is in progress. Alternatively, a user might wish to include another person in an existing telephone conversation by bridging the person's telephone into the call; this is also known as conference calling.

Forwarding is also commonly employed for email. In particular, a forwarding mechanism is established (e.g., creating a .forward file in a UNIX-based system, etc.) so that email messages directed to a first address are automatically forwarded to a second address.

### SUMMARY OF THE INVENTION

The present invention enables signals (e.g., voice, video, text, etc.) directed to a first telecommunications terminal (e.g., telephone, computer, pager, etc.) to be forwarded to a second telecommunications terminal only when such forwarding is authorized. In particular, the illustrative embodiment employs authorization tables associated with the first telecommunications terminal and the second telecommunications terminal, respectively, and forwards signals directed to the first terminal to the second terminal only when the authorization tables indicate that such forwarding is permitted.

The illustrative embodiment comprises a method comprising: receiving a request to forward a signal directed to a first telecommunications terminal to a second telecommunications terminal; determining if the first telecommunications terminal is authorized to forward to the second telecommunications terminal; and forwarding the signal only when the first telecommunications terminal is authorized to forward to the second telecommunications terminal.

### BRIEF DESCRIPTION OF THE DRAWINGS

FIG. 1 is a representational diagram depicting illustrative authorization tables 110 and 120 associated with a contact identifier, in accordance with the illustrative embodiment of the present invention.

FIG. 2 depicts a flowchart of a method for processing a forwarding request, in accordance with the illustrative embodiment of the present invention.

FIG. 3 depicts a schematic diagram of an illustrative telephony-based telecommunications system 300 in the prior art.

FIG. 4 depicts a block diagram of the salient components of wireless network 310, as shown in FIG. 3, and public switched telephone network (PSTN) 320, as shown in FIG. 3, in the prior art.

FIG. 5 depicts wireless network 310 and PSTN 320, as shown in FIG. 4, connected to authorization database server 510 in accordance with the illustrative embodiment of the present invention.

### DETAILED DESCRIPTION

Definitions—Although the illustrative embodiment is disclosed in the context of telephones, it will be clear to those skilled in the art how to make and use embodiments of the present invention for other devices such as pagers, personal digital assistants (PDAs), etc. Consequently, for the purposes of this specification the term “contact identifier” and its inflected forms are defined as a string of symbols that uniquely specifies a telecommunications terminal (e.g., telephone number, email address, Internet Protocol (IP) address, etc.). Similarly, for the purposes of this specification the term “call” is defined to encompass all kinds of communications (e.g. telephone call, email message, interactive text chat, videoconference, etc.), and it will be clear to those skilled in the art how to make and use embodiments of the present invention for such alternative means of communication.

For the purposes of this specification, the term “forwarding out” and its inflected forms are defined as forwarding a call from a first telecommunications terminal to a second telecommunications terminal as a result of a forwarding request originating at the first telecommunications terminal. Similarly, for the purposes of this specification the term “forwarding in” and its inflected forms are defined as forwarding a call from a first telecommunications terminal to a second telecommunications terminal as a result of a forwarding request originating at the second telecommunications terminal.

For some kinds of communication, such as telephone calls and interactive text chat, forwarding can be established either: (i) before a call is initiated, or (ii) during a call (i.e., while a call is in progress). For some other kinds of communication such as email, however, forwarding typically applies to (i) only.

For case (i), a call can be forwarded from a first terminal to a second terminal so that either (ia) only the second terminal is notified of the incoming call (i.e., only the second terminal “rings”), or (ib) both the first and second terminals are notified of the incoming call (i.e., both terminals ring). For case (ii), a call can be forwarded from a first terminal to a second terminal so that either (iia) the first communications terminal no longer participates in the call (i.e., only the second terminal participates), or (iib) the first terminal still participates in the call (i.e., both terminals participate).

Consequently, for the purposes of this specification: the term “redirecting” and its inflected forms are defined as forwarding a call or message in accordance with (ia) above; the term “connecting” and its inflected forms are defined as forwarding a call or message in accordance with (ib) above; the term “transferring” and its inflected forms are defined as forwarding a call or message in accordance with (iia) above; and the term “bridging” and its inflected forms are defined as forwarding a call or message in accordance with (iib) above.

In addition, for the purposes of this specification: the term “redirecting out” and its inflected forms are defined as forwarding out a call or message in accordance with (ia) above; the term “connecting out” and its inflected forms are defined as forwarding out a call or message in accordance with (ib) above; the term “transferring out” and its inflected forms are defined as forwarding out a call or message in accordance with (iia) above; and the term “bridging out” and its inflected forms are defined as forwarding out a call or message in accordance with (iib) above.

Similarly, for the purposes of this specification: the term “redirecting in” and its inflected forms are defined as forwarding in a call or message in accordance with (ia) above; the term “connecting in” and its inflected forms are defined as forwarding in a call or message in accordance with (ib) above; the term “transferring in” and its inflected forms are defined as forwarding in a call or message in accordance with (iia) above; and the term “bridging in” and its inflected forms are defined as forwarding in a call or message in accordance with (iib) above.

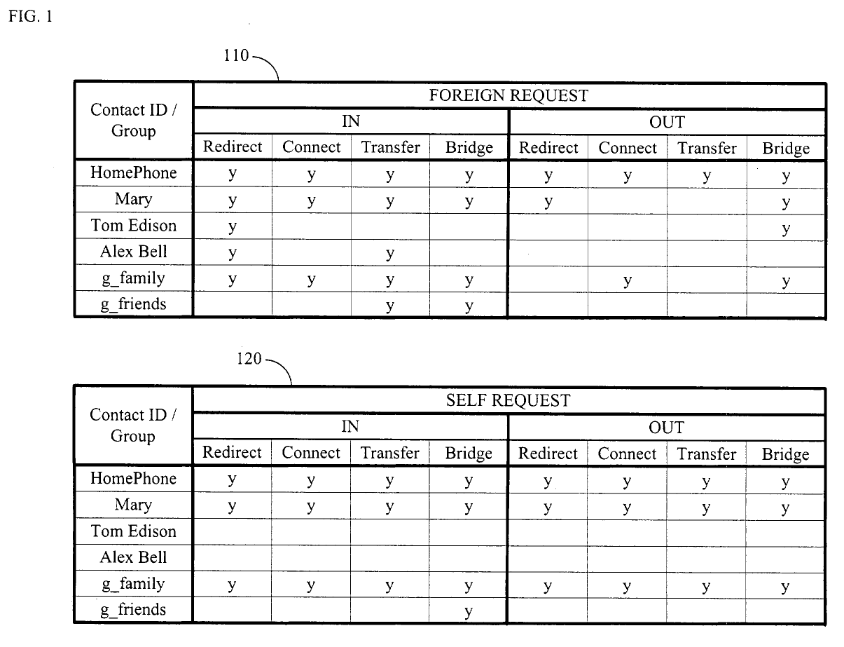

The Illustrative Embodiment—FIG. 1 depicts illustrative authorization tables 110 and 120 associated with a particular contact identifier (e.g., 555-555-5555, etc.), in accordance with the illustrative embodiment of the present invention. For illustrative purposes, the contact identifier is assumed to be the phone number of a wireless telephone belonging to a user “Bob.”

As shown in FIG. 1, the contact identifier has two associated authorization tables; table 110 corresponds to “foreign requests,” wherein another party is the originator of the forwarding request, and table 120 corresponds to “self requests,” wherein the telecommunications terminal corresponding to the contact identifier (i.e., Bob's wireless telephone) is the originator of the forwarding request. For both table 110 and 120, entries in the first column, labeled “User/Group,” correspond to symbols (i.e., names) associated with either a single contact identifier, or a group of associated contact identifiers. In the illustrative tables of FIG. 1, “HomePhone” corresponds to Bob's home telephone number, “Mary” corresponds to Bob's wife's wireless telephone number; “Tom Edison” corresponds to Bob's mid-level boss' work telephone number; “Alex Bell” corresponds to Bob's top-level boss' work telephone number; “g_family” refers to a group of home telephone numbers corresponding to Bob's family members; and “g_friends” refers to a group of home telephone numbers corresponding to Bob's friends.

In some embodiments, a user might define user and group names, as well as the mappings of these names to contact identifiers, via a telecommunications terminal's user interface (e.g., keypad entry, touch screen, etc.). In some other embodiments, contact identifiers could be stored directly in the first column in lieu of names, thereby eliminating the need for a secondary lookup to associate names with contact identifiers. (Details concerning the storage of authorization tables 110 and 120 is disclosed below.)

As shown in FIG. 1, both table 110 and 120 have eight permission entries for each user/group, corresponding to: redirecting in (column 2), connecting in (column 3), transferring in (column 4), bridging in (column 5), redirecting out (column 6), connecting out (column 7), transferring out (column 8), and bridging out (column 9). For example, the second column of table 110 indicates whether a telecommunications terminal belonging to a particular user/group is allowed to redirect calls into Bob's wireless telephone; the eighth column of table 110 indicates a telecommunications terminal belonging to a particular user/group is allowed to transfer out (i.e., “seize”) calls from Bob's wireless telephone into that terminal. As shown in FIG. 1, a “y” indicates that a particular forwarding operation is allowed, while a blank indicates that it is not.

Similarly, table 120 specifies which forwarding operations Bob's wireless telephone is allowed to perform. In some cases a user might not want to place any constraints on his or her own forwarding abilities (i.e., let the other telecommunications terminal's user “stop me”), in which case table 120 is unnecessary (i.e., every entry in table 120 is a “y”). However, there might be some situations in which such constraints are desirable. For example, a corporate vice president might configure authorization table 120 for his or her wireless telephone so that he or she is not permitted to forward calls to the CEO's wireless telephone, even if the CEO has set authorization table 110 for his or her wireless telephone to allow such forwarding, in order to avoid accidentally doing so.

In some embodiments, a user might set and modify the individual permissions of authorization tables 110 and 120 via a telecommunications terminal's user interface, as described above. In some other embodiments, a general security policy selected by the user (e.g., “friendly [low security],” “recommended [medium],” “paranoid [high],” etc.) might be used to determine the individual entries of authorization tables 110 and 120, as is well known in the art. (Such policies are sometimes used, for example, in firewalls).

In addition, authorization tables 110 and 120, as disclosed, are “white lists” (i.e., any contact identifier not covered by an entry in the user/group column is automatically prohibited from performing any forwarding operation). As will be clear to those skilled in the art, authorization tables 110 and 120 could alternatively be “black lists” (i.e., any contact identifier not covered by an entry in the user/group column is automatically allowed to performing any forwarding operation.)

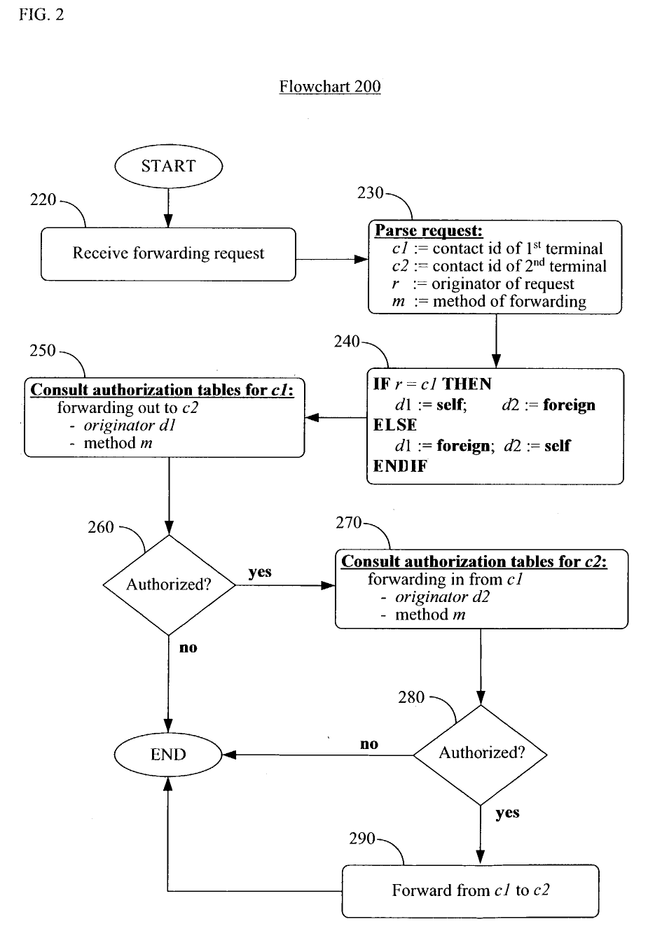

FIG. 2 depicts a flowchart 200 of a method for processing a forwarding request, in accordance with the illustrative embodiment of the present invention. In particular, the method depicted in FIG. 2 accepts a request for forwarding a signal from a first telecommunications terminal to a second telecommunications terminal, and determines whether to forward the signal based on the appropriate authorization tables.

At task 220, a request for forwarding a signal from a first telecommunications terminal to a second telecommunications terminal is received. The forwarding request comprises: (1) the contact identifier of the first terminal; (2) the contact identifier of the second terminal; (3) an indication of the originator of the request (i.e., the first telecommunications terminal or the second telecommunications terminal); and (4) the method of forwarding (i.e., redirecting, connecting, transferring, or bridging).

At task 230, the request is parsed and data items (1) through (4) are stored, respectively, in variables c1, c2, r, and m.

At task 240, the values of two variables d1 and d2 are set. Variable d1 indicates the originator of the request (“self” or “foreign”) with respect to the first telecommunications terminal's point of view, and variable d2 indicates the originator of the request with respect to the second telecommunications terminal's point of view. Thus, if the first terminal made the request (i.e., r=c1), then d1 is set to “self” and d2 is set to “foreign”; otherwise, d1 is set to “foreign” and d2 is set to “self”.

At task 250, a table lookup is performed to determine if the first telecommunications terminal is authorized to forward to the second telecommunications terminal based on the first terminal's permissions. As described above, each contact identifier has associated authorization tables 110 and 120. If d1=“foreign,” then the lookup is performed on authorization table 110 associated with the first telecommunications terminal; otherwise the lookup is performed on authorization table 120 associated with the first telecommunications terminal. Once the appropriate table is determined, the particular entry corresponding to c2/“OUT”/m is located. (As described above, a preliminary lookup might be required to determine the name associated with contact identifier c2.)

Task 260 checks whether the above table entry contains a “y”. If so, execution proceeds to task 270; otherwise the method of FIG. 2 terminates, as the forwarding operation is not authorized by the first telecommunications terminal.

At task 270, a table lookup is performed to determine if the first telecommunications terminal is authorized to forward to the second telecommunications terminal based on the second terminal's permissions. In a manner similar to task 250, the appropriate authorization table is determined based on d2, and entry c1/“IN”/m in the table is located.

Task 280 checks whether the table entry located in task 270 contains a “y”. If so, execution proceeds to task 290; otherwise the method of FIG. 2 terminates, as the forwarding operation is not authorized by the second telecommunications terminal.

At task 290, the forwarding request is fulfilled and the method of FIG. 2 terminates. As is well understood in the art, for telephone calls a forwarding message is sent to the appropriate switch's adjunct processor, which causes: (i) the corresponding forward flag in the record for contact identifier c1 to be enabled, and (ii) the forwarding number in this record to be set to contact identifier c2. It will be clear to those skilled in the art how to configure the various switches to implement redirecting, connecting, transferring, and bridging.

For email, a message is sent over the Internet to the appropriate email server to establish forwarding of messages directed to contact identifier c1 to contact identifier c2, as is well understood in the art. For peer-to-peer communications employing the Session Initiation Protocol (SIP), such as instant messaging (IM), a message is sent over the Internet to the appropriate SIP server to update the user's current contact identifier (i.e., IP address) to c2, as is well understood in the art.

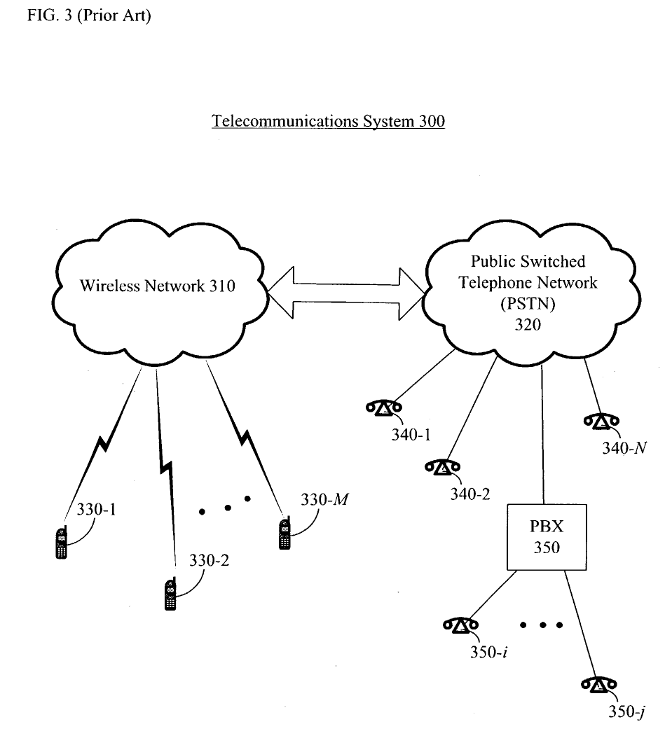

FIG. 3 depicts a schematic diagram of the salient components of a telephony-based telecommunications system 300 in the prior art. As shown in FIG. 3, telecommunications system 300 comprises wireless network 310, PSTN 320, private branch exchange (PBX) 350, wireless telecommunications terminals 330-1 through 330-M, and wireline telecommunications terminals 340-1 through 340-N. Wireline telecommunications terminals 340-1 through 340-N are connected to PSTN 320 either directly or via PBX 350, as is well-known in the art. Similarly, wireless telecommunications terminals 330-1 through 330-M communicate wirelessly with wireless network 310, as is well understood in the art.

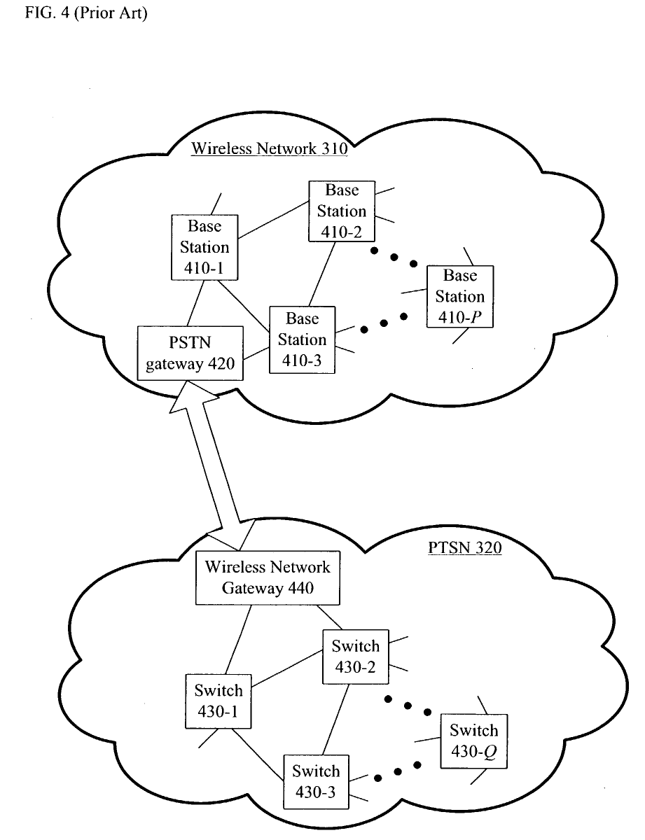

FIG. 4 depicts the salient components of wireless network 310 and PSTN 320 in the prior art. As shown in FIG. 4, wireless network 310 comprises a mesh of base stations 410-1 through 410-P, as is well known in the art, and PSTN gateway 420 for communicating with PSTN 320. PSTN 320 comprises switches 430-1 through 430-Q, as is well known in the art, and wireless network gateway 440 for communicating with wireless network 310.

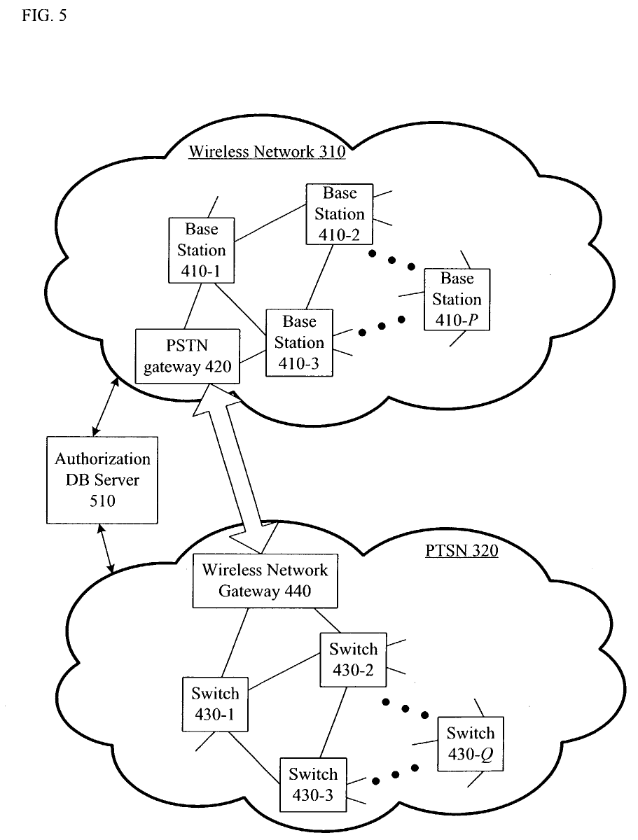

FIG. 5 depicts wireless network 310 and PSTN 320, as shown in FIG. 4, connected to authorization database server 510 in accordance with the illustrative embodiment of the present invention. Authorization database server 510 hosts a centralized database that stores authorization tables 110 and 120 for telecommunications terminals. As is well known in the art, the database hosted at server 510 might be a relational database, object-oriented database, hierarchical database, etc. It will also be clear to those skilled in the art that in some embodiments a distributed database might be employed in lieu of a centralized database.

As described above, in some embodiments a user might set and modify the contents of the authorization tables 110 and 120 associated with his or her telecommunications terminal via the terminal's user interface. In such embodiments, the contents of tables 110 and 120 could be downloaded from authorization database server 510 to the terminal for viewing and/or editing, and changes input via the user could be uploaded to server 510 in well-known fashion. In some other embodiments, a user might be able to enter permissions through a webpage that could be accessed via any browser-enabled telecommunications terminal. As will be clear to those skilled in the art, in some embodiments of this type, a web server serving the webpage could be programmed to submit a query to authorization database server 510 for viewing and/or updating tables 110 and 120 accordingly.

When a wireless telecommunications terminal submits a forwarding request while in base station 410-i's coverage, base station 410-i sends the request via wireless network 310 to authorization database server 510. Authorization database server 510 parses the request and performs the corresponding query (or queries, if required), as described in tasks 230 through 280 above. If the result of the query (or queries) indicates that forwarding is not authorized, a negative acknowledgement response is sent to base station 410-i. Otherwise, authorization database server 510 sends a forwarding message to the PSTN switch 430 (or base station 410) corresponding to contact identifier c1. As is well known in the art, the forwarding message causes the forwarding flag(s) and forwarding number(s) for the record corresponding to c1 to be modified accordingly. After modifying the record, the corresponding PSTN switch 430 (or base station) sends a positive acknowledgement to the base station 410-i from which the forwarding request originated. If desired, base station 410-i can send a message to the telecommunications terminal corresponding to contact identifier c1 to notify its user of the result (i.e., positive or negative acknowledgement) of the attempted forwarding.

In some embodiments, authorization database server 510 might also send a positive or negative acknowledgement message, as appropriate, to the telecommunications terminal corresponding to contact identifier c2 (via the appropriate PSTN switch 430 or base station 410). The user of this terminal thus can be informed that an attempt was made to forward to the terminal, by whom, and whether the attempt was successful.

When a wireline telecommunications terminal in switch 430-i's domain submits a forwarding request, switch 430-i sends the request via PSTN 320 to authorization database server 510. Authorization database server 510 then checks, as above, whether the forwarding is authorized and sends a forwarding message or negative acknowledgement, as appropriate. Acknowledgements, both positive and negative, are sent to the switch 430-i from which the forwarding request originated; switch 430-i can then send a notification message to the telecommunications terminal corresponding to contact identifier c1, as above. In some embodiments, authorization database server 510 might also send a notification message to the telecommunications terminal corresponding to contact identifier c2, as above.

It will be clear to those skilled in the art that the above methods for forwarding in wireless and wireline telephony networks can be adapted with minimal changes to wireless and wireline data networks (e.g., “Wi-Fi” networks and the Internet, respectively). For example, forwarding email instead of a telephone call requires that a forwarding message be sent to an appropriate email server, rather than a PSTN switch 430 or base station 410. Similarly, forwarding an instant messaging (IM) message or a voice-over-IP (VoIP) telephone call requires that a forwarding message be sent to an appropriate SIP or VoIP server, respectively, as is well known in the art.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method comprising:
(a) receiving a request to forward a signal directed to a first telecommunications terminal to a second telecommunications terminal;
(b) determining if said first telecommunications terminal is authorized to forward to said second telecommunications terminal; and
(c) forwarding said signal only when said first telecommunications terminal is authorized to forward to said second telecommunications terminal.

2. The method of claim 1 wherein said forwarding is selected from the group consisting of: redirecting, transferring, bridging, and connecting.

3. The method of claim 1 wherein said request comprises at least one of:
a contact identifier associated with said first telecommunications terminal; and
a contact identifier associated with said second telecommunications terminal.

4. The method of claim 1 wherein said first telecommunications terminal is the originator of said request.

5. The method of claim 1 wherein said determining is based on an authorization table associated with said second telecommunications terminal.

6. The method of claim 5 wherein at least one entry in said authorization table is associated with a plurality of users.

7. The method of claim 1 wherein said second telecommunications terminal is the originator of said request.

8. The method of claim 1 wherein said determining is based on an authorization table associated with said first telecommunications terminal.

9. The method of claim 8 wherein at least one entry in said authorization table is associated with a plurality of users.

10. The method of claim 1 wherein at least one of said first telecommunications terminal and said second telecommunications terminal is wireless.

11. An apparatus comprising:
a memory for storing authorization information;
a processor for:
receiving a request to forward a signal directed to a first telecommunications terminal to a second telecommunications terminal, and
determining if said first telecommunications terminal is authorized to forward to said second telecommunications terminal based on the contents of said memory; and
a switch for forwarding said signal only when said first telecommunications terminal is authorized.

12. The apparatus of claim 11 wherein said forwarding is selected from the group consisting of: redirecting, transferring, bridging, and connecting.

13. The apparatus of claim 11 wherein:
said memory stores an authorization table associated with said second telecommunications terminal; and
said processor's determining is based on said authorization table.

14. The apparatus of claim 11 wherein:
said memory stores an authorization table associated with said first telecommunications terminal; and
said processor's determining is based on said authorization table.

15. The apparatus of claim 11 wherein:
said memory stores:
a first authorization table associated with said first telecommunications terminal, and
a second authorization table associated with said second telecommunications terminal; and
said processor's determining is based on said first authorization table and said second authorization table.

16. An apparatus comprising:
a memory for storing authorization information;
a processor for:
receiving a request to forward a signal directed to a first telecommunications terminal to a second telecommunications terminal, and
determining if said first telecommunications terminal is authorized to forward to said second telecommunications terminal based on the contents of said memory; and
a transmitter for forwarding said signal only when said first telecommunications terminal is authorized.

17. The apparatus of claim 16 wherein said forwarding is selected from the group consisting of: redirecting, transferring, bridging, and connecting.

18. The apparatus of claim 16 wherein:
said memory stores an authorization table associated with said second telecommunications terminal; and
said processor's determining is based on said authorization table.

19. The apparatus of claim 16 wherein:
said memory stores an authorization table associated with said first telecommunications terminal; and
said processor's determining is based on said authorization table.

20. The apparatus of claim 16 wherein:
said memory stores:
a first authorization table associated with said first telecommunications terminal, and
a second authorization table associated with said second telecommunications terminal; and
said processor's determining is based on said first authorization table and said second authorization table.
